(19) United States
(12) Patent Application Publication
(10) Pub. No.: US 2024/0104143 A1
(43) Pub. Date: Mar. 28, 2024

(54) METHODS AND APPARATUS TO STORE CLUSTER INFORMATION IN A DISTRIBUTED DATASTORE

(71) Applicant: VMware, Inc., Palo Alto, CA (US)

(72) Inventors: Brian Masao Oki, San Jose, CA (US); Chaitanya Bandi, Pflugerville, TX (US); Subhankar Biswas, San Jose, CA (US); Austin Kramer, Redwood City, CA (US); Leonid Livshin, Malden, MA (US); Alkesh Shah, Sunnyvale, CA (US); Pradyumna Agrawal, Sunnyvale, CA (US); Cheng Cheng, Cupertino, CA (US); Andrew Stone, Malden, MA (US)

(21) Appl. No.: 17/954,269

(22) Filed: Sep. 27, 2022

(51) Int. Cl. G06F 16/906; G06F 11/14

(52) U.S. Cl. CPC G06F 16/906; G06F 11/1458; G06F 2201/805

(57) ABSTRACT

Methods, apparatus, systems, and articles of manufacture to store cluster information in a distributed datastore are disclosed. An example apparatus includes memory; programmable circuitry; and first instructions to cause the programmable circuitry to: obtain second instructions to create a cluster of first hosts; determine second hosts of the cluster of the first hosts to implement a distributed datastore in the cluster; and cause transmission of third instructions to store cluster information corresponding to the cluster of the first hosts in datastores of the second hosts.

### FIELD OF THE DISCLOSURE

This disclosure relates generally to computing environments, and, more particularly, to methods and apparatus to store cluster information in a distributed datastore.

### BACKGROUND

Computing environments often include many virtual and physical computing resources. For example, software-defined data centers (SDDCs) are data center facilities in which many or all elements of a computing infrastructure (e.g., networking, storage, CPU, etc.) are virtualized and delivered as a service. The computing environments often include management resources for facilitating management of the computing environments and the computing resources included in the computing environments. Some of these management resources include the capability to automatically monitor computing resources and generate alerts when compute issues are identified. Additionally or alternatively, the management resources may be configured to provide recommendations for responding to generated alerts. In such examples, the management resources may identify computing resources experiencing issues and/or malfunctions and may identify methods or approaches for remediating the issues. Recommendations may provide an end user(s) (e.g., an administrator of the computing environment) with a list of instructions or a series of steps that the end user(s) can manually perform on a computing resource(s) to resolve the issue(s). Although the management resources may provide recommendations, the end user(s) is responsible for implementing suggested changes and/or performing suggested methods to resolve the compute issues.

### BRIEF DESCRIPTION OF THE DRAWINGS

FIG. 1 is a block diagram of an example environment to store cluster information in a distributed datastore.

FIG. 2A is a block diagram of an example implementation of the example cluster membership manager (CMM) circuitry of FIG. 1.

FIG. 2B is a block diagram of an example implementation of the example cluster agent of FIG. 1.

FIGS. 3 and 4 illustrate flowcharts representative of example machine-readable instructions that may be executed by example processor circuitry to implement the example CMM circuitry of FIG. 1 and/or FIG. 2A.

FIG. 5 illustrates a flowchart representative of example machine-readable instructions that may be executed by example processor circuitry to implement the example cluster agent of FIG. 1 and/or FIG. 2B.

FIG. 6 is a block diagram of an example processor platform including processor circuitry structured to execute the example machine-readable instructions of FIGS. 3-4 to implement the example CMM circuitry of FIG. 1 and/or FIG. 2A.

FIG. 7 is a block diagram of an example processor platform including processor circuitry structured to execute the example machine-readable instructions of FIG. 5 to implement the example cluster agent of FIG. 1 and/or FIG. 2B.

FIG. 8 is a block diagram of an example implementation of the processor circuitry of FIG. 6 and/or FIG. 7.

FIG. 9 is a block diagram of another example implementation of the processor circuitry of FIG. 6 and/or FIG. 7.

FIG. 10 is a block diagram of an example software distribution platform (e.g., one or more servers) to distribute software (e.g., software corresponding to the example machine-readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

The figures are not to scale. Instead, the thickness of the layers or regions may be enlarged in the drawings. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

Virtual computing services enable one or more assets to be hosted within a computing environment. As disclosed herein, an asset is a computing resource (physical or virtual) that may host a wide variety of different applications such as, for example, an email server, a database server, a file server, a web server, etc. Example assets include physical hosts (e.g., non-virtual computing resources such as servers, processors, computers, etc.), virtual machines, containers that run on top of a host operating system without the need for a hypervisor or separate operating system, hypervisor kernel network interface modules, etc. In some examples, an asset may be referred to as a compute node, an end-point, a data computer end-node or as an addressable node.

Virtual machines operate with their own guest operating system on a host using resources of the host virtualized by virtualization software (e.g., a hypervisor, virtual machine monitor, etc.). Numerous virtual machines can run on a single computer or processor system in a logically separated environment (e.g., separated from one another). A virtual machine can execute instances of applications and/or programs separate from application and/or program instances executed by other virtual machines on the same computer.

A server manager (e.g., vCenter®) allow users and/or administrators to control the structure and/or operation of hosts in a network. For example, a server manager can group hosts into clusters to pool the hosts resources to enable high availability and/or distributed resource functionality. Clustering resources provides protection from software and/or hardware failures related to any particular host within the cluster. In some examples, the user and/or administrator can instruct the server manager to store cluster information related to clusters of hosts within the network. In this manner, if a backup and/or restore is needed (e.g., due to a hardware and/or software failure at the server manager), the server manager can access the stored cluster information to restore the previously developed clusters within the network. However, server managers rely on a user and/or administrator to update the system state (e.g., the cluster information) periodically and/or after an update. However, some users rarely update the system state and/or clusters may automatically update in response to particular events and if the system state is not updated at the server manager, the system state stored at the server manager is out-of-date. Additionally, if the failure at the system manager affects the database that stores the system state or the database is corrupted, the system state information may be corrupt and cannot be accessed during a reboot, restore, and/or backup. As used herein, cluster information or cluster state information refers to the structure of a particular cluster and or system state information corresponds to the cluster information of all clusters in a system.

Accordingly, if the system state information stored in a database of the server manager is outdated or corrupted, a simple crash or hardware failure will cause the server system to reboot to a system state that is no longer relevant, available, and/or trustworthy (e.g., if the failure was part of a malicious attack). Because it is difficult to infer a system state by examining the system state from the server manager, an outdated backup or corrupted database cannot be easily patched to reflect the current system state.

Examples disclosed herein alleviate the problems associated with outdated and/or corrupted system state information stored in a server manager by storing system state information in a distributed store across hosts in a cluster (e.g., a highly available key-value cluster store). As used herein, a cluster (also referred to as an autonomous cluster, a pod, an autonomous pod, an elastic sky X (ESX) cluster, an ESX pod, etc.) is a group of hosts which users and/or administrators may provision VMs and/or PodVM workloads and manage cluster resources by interacting directly with the cluster though a communication endpoint (e.g., with or without a server manager). The example distributed store includes replica databases in different hosts of a cluster that each store the same cluster information (e.g., to facilitate high availability, strong data consistency, linearizable operations, failure independence, persistence, etc.). As used herein a host that implements a replica database is referred to as a replica host. As used herein, high availability relates to data and/or server that are available to a high probability such that they are able to be accessed while meeting consistency guarantees, strong data consistency relates to data corresponding to the last data written even in the presence of concurrent activities and/or failures, linearizable operations relates to operations of the cluster store being atomically consistent with respect to other operations, failure independence relates to failure of one host not affecting the operation of other hosts in a cluster, and persistence relates to data surviving failures of a host and the storage being consistent with the data guarantees. By storing cluster data directly on the cluster, the system state can be maintained and updated with changes in state regardless of software and/or hardware failures at the server manager, thereby reducing reliance on the server manager and avoiding outdated and/or corrupted system state information in the server manager.

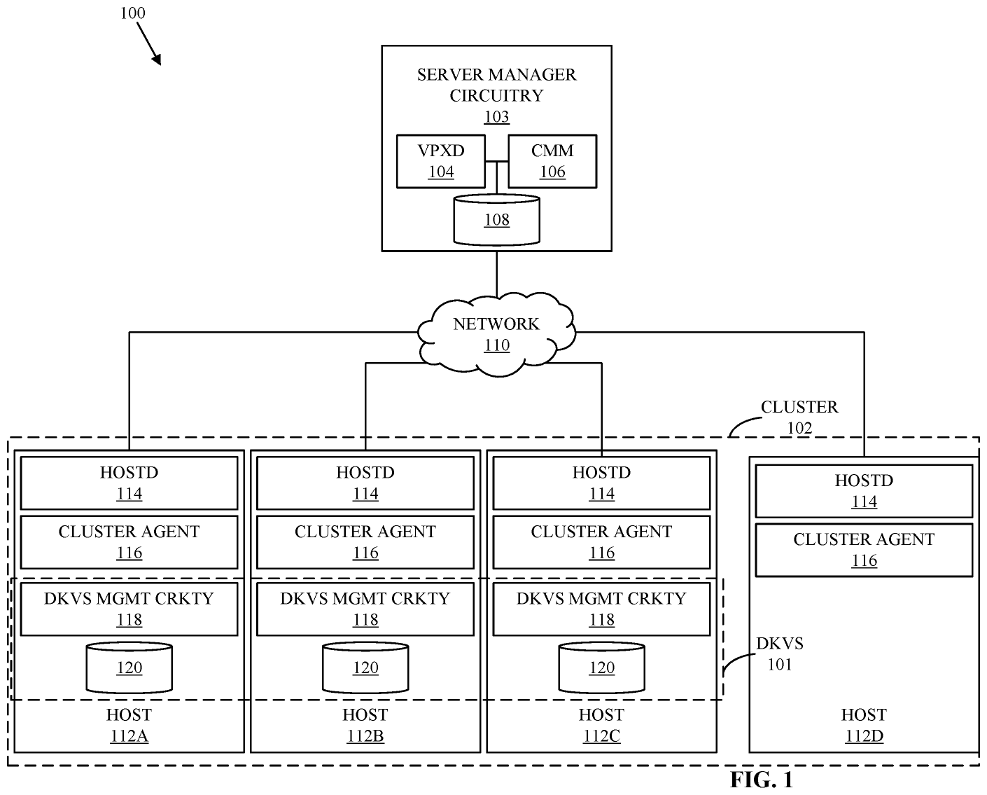

FIG. 1 is a block diagram of an example environment 100 in which an example distributed key value store (DKVS) 101 is implemented in an example cluster 102. The example environment 100 includes server manager circuitry 103, example provisioning circuitry agent (e.g., virtual provisioning X daemon (VPXD)) circuitry 104, example cluster membership manager (CMM) circuitry 106, an example database 108, an example network 110, and the example cluster 102. The example cluster 102 includes example hosts 112a-112d, example host daemon (hostd) circuitry 114, example cluster agent circuitry 116, example DKVS management (MGMT) circuitry (CRKTY) 118, and example datastores 120. Although the example of FIG. 1 includes one cluster with four host devices and three replica datastores in a DKVS, there may be any number of hosts in any number of clusters with any number of replica datastores. Alternatively, the example computing environment 100 may be any type of computing resource environment such as, for example, any computing system utilizing network, storage, and/or server virtualization.

The example DKVS 101 of FIG. 1 is a highly available distributed cluster store across the example hosts 112a-112c. The DKVS 101 stores records data persistently and reliably. The DKVS 101 stores information about the structure of the cluster 102. In some examples, the DKVS 101 is a key value store for <key, value>tuples. A key may be an ASCII string and a value is an object. The example DKVS 101 operates as a single logical server, but is physically distributed across a subset of the hosts 112a-112c to provide availability. To guarantee semantics of a single logical server, the DKVS 101 includes the example DKVS management circuitry 118. In this manner, the stored replicated data behave like a single data object, as further described below. In some examples, the DKVS 101 implements a leader-based replication protocol to implement the single logical object semantics. For example, a designated leader host of the hosts 112a-112c that implement the DKVS 101 handles the reads, updates, etc., communicates operations with the follower hosts, and/or employs a distributed consensus protocol (e.g., a Raft protocol). If the leader is inaccessible, the protocol guarantees a new leader will be elected and no data will be lost.

The example server management circuitry 103 (e.g., Vcenter®) of FIG. 1 is a computing device and/or server that manages connected hosts (e.g., the example hosts 112a-112d) to generate and/or control the example DKVS 101. In some examples, the server management circuitry 103 allows a user and/or administrator to access, control, automate, and/or manage the hosts 112a-112d, virtual machines, and/or other components across a network from a single centralized location. The example server management circuitry 103 includes the example VPXD circuitry 104, the example CMM circuitry 106, and an example database 108. The example VPXD circuitry 104 of FIG. 1 facilitates communications with the example hosts 112a-112d. For example, the VPXD circuitry 104 may include a VMware® Managed Object Design Language (VMODL) stub to make remote procedure call (RPC) calls to a management host (e.g., one or more of the example hosts 112a-112d) via the example network 110 using the example hostd circuitry 114.

The example server management circuitry 103 of FIG. 1 further includes the example CMM circuitry 106. The example CMM circuitry 106 manages the example cluster 102 and/or other connected hosts and/or clusters. In some examples, the CMM circuitry 106 is part of a server appliance (e.g., a vCenter service appliance (VCSA)). The example CMM circuitry 106 may implement high level operations that translate to invocations of an application programming interface (API) of one or more of the hosts 112a-112d. The example CMM circuitry 106 orchestrates communication from/to the server management circuitry 103 to/from the example hosts 112a-112d. Additionally, the example CMM circuitry 106 configures the example cluster 102 of the example hosts 112a-112d based on instructions from a user, administrator, and/or device. The example CMM circuitry 106 provides an API to reconcile cluster membership (e.g., which hosts to include in and/or adjust from a cluster) and preserves an invariant that the actual membership is identical to the intended membership. In some examples, the CMM circuitry 106 enforces desired fault-tolerant policy for a cluster store (e.g., a distributed cluster store and/or a DKVS) by executing a background process that runs periodically, aperiodically, and/or based on a trigger (e.g., an event or instruction) to check whether enforcement of the fault-tolerant policy is satisfied and takes steps to rectify any issues if enforcement is not satisfied. To isolate users and/or administrators from the vagaries of the cluster 102, the CMM circuitry 106 provides a communication handle so that the users and/or administrators can interact with the cluster store service via an API. In some examples, the CMM circuitry 106 may use a handle (e.g., an object with methods) to access remote services. In some examples, the user and/or administrator may utilize the CMM circuitry 106 to store a <key, value>tuple in the example DKVS 101, retrieve a value, give a key, perform range queries, etc. In some examples, each API operation may be linearizable because the operation guarantees atomic consistency of its execution in the presence of failures and concurrent operations so that the effects of the operation fully occur without compromised consistency.

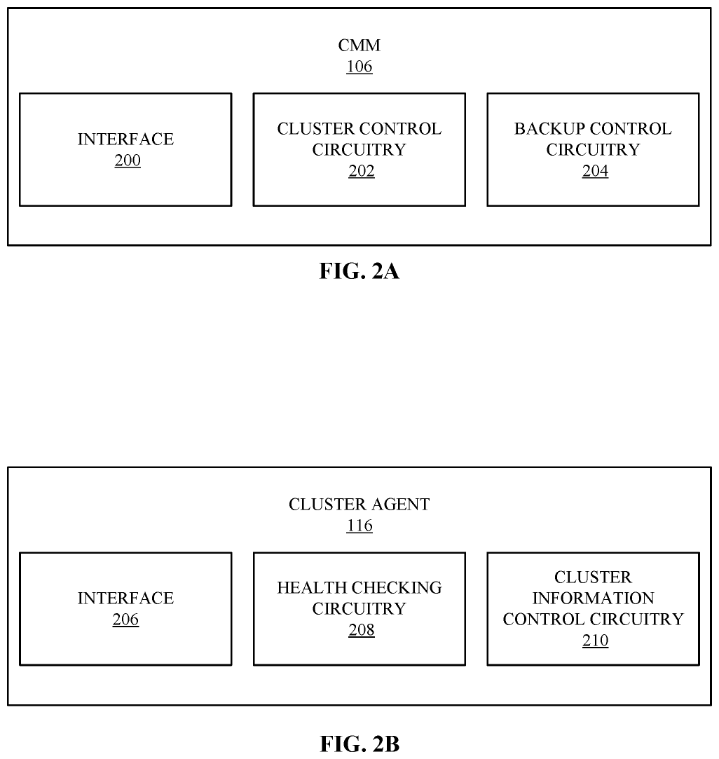

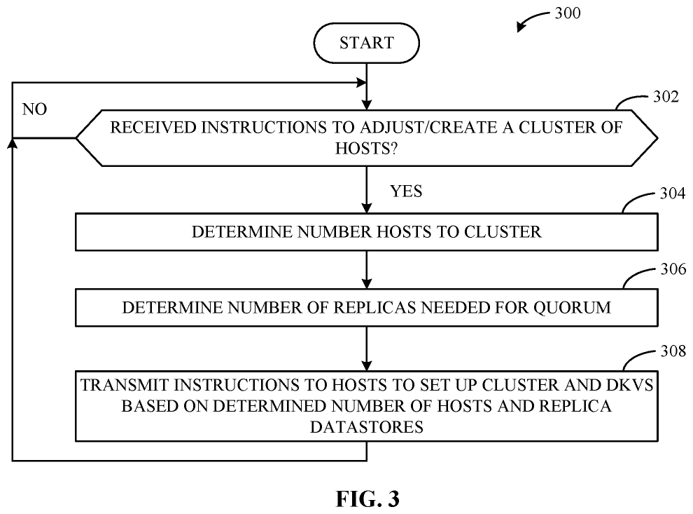

Because the CMM circuitry 106 of FIG. 1 sets up the storage of cluster information in the cluster 102 itself by creating the example DKVS 101, the cluster information of a cluster is stored in the example datastores 120 of the example DKVS 101, when a reboot, restart, backup, etc. occurs, the example CMM circuitry 106 transmits cluster information requests to any connected host (e.g., the example hosts 112a-112d). After cluster information is obtained from a host, the CMM circuitry 106 identifies the cluster of hosts and continues to ping subsequent hots that are not included in the cluster until the CMM circuitry 106 develops a map of all hosts and/or clusters in the network. In this manner, after a reboot, backup, restart, etc. the example server manager circuitry 103 can continue operation based on the developed and up-to-date cluster structures prior to the reboot, backup, restart, etc. In some examples, one or more operations executed by the example CMM circuitry 106 may be performed on a different device (e.g., on one or more of the example hosts 112a-112d). In some examples, the CMM circuitry 106 has an instance per cluster. In such examples, the VPXD circuitry 104 manages each cluster and maintains the CMM circuitry 106 for each cluster where the DKVS 101 is deployed. The example CMM circuitry 106 is further described below in conjunction with FIG. 2A.

The example server manager circuitry 103 further includes an example database 108. The example database 108 stores information. As described above, conventional server manager circuitry stored system state information (e.g., cluster configurations of connected hosts within the environment 100). However, such data is more likely to be outdated and such data may be corrupted due to hardware and/or software failures, thereby losing the system state information stored in the database 108. Accordingly, the example CMM circuitry 106 facilitates the storage of system state information in the example DKVS 101. In some examples, the server manager circuitry 103 may store failed operations in a log in the example database 108 for execution at a subsequent point in time. For example, if server manager circuitry 103 transmits a request to read and/or write data into the DKVS 101 and receives a response corresponding to a failure (e.g., because there was no quorum in the cluster 102, because of an error at one of more of the hosts 112a-112d, etc.), the CMM circuitry 106 may log the failed request in a log stored in the database 108. In this manner, the CMM circuitry 106 may attempt to retransmit the request at a later point in time.

The example server manager circuitry 103 of FIG. 1 communications with one or more of the hosts 112a-112d via the example network 110. The example network 110 communicatively couples computers and/or computing resources of the example computing environment 100. In the illustrated example of FIG. 1, the example network 110 is a computing network that facilitates access to shared computing resources. In examples disclosed herein, information, computing resources, etc. are exchanged among the example hosts(s) 112a-112d and/or the example server manager circuitry 103 via the example network 110. The example network 110 may be a wired network, a wireless network, a local area network, a wide area network, and/or any combination of networks.

The example cluster 102 of FIG. 1 includes the example hosts 112a-112d. In some examples, the hosts 112a-112d are ESX hosts and the example cluster 102 is a ESX cluster. The example cluster 102 is a collection of hosts named by a globally unique identifier. The example cluster 102 performs services (e.g., like a Cluster store or DKVS). The example cluster 102 may include set of low-level APIs to give a caller control over the cluster construction 102, determine how many hosts are required to provide a specified level of fault-tolerance and/or quorum for the DKVS 101. In some examples, the cluster 102 may explicitly create and/or determine placement of the DKVS 101. The example cluster 102 provides an API to obtain a communication handle to interface with the DKVS 101 or any service exported by the cluster 102. In some examples, the hosts 112a-112d of the cluster 102 may not know which hosts are members of the cluster 102. Such information may only be known by the host that is designated the leader of the DKVS 101. In such examples, the cluster information is stored in the example distributed datastores 120 of the DKVS 101. However, the example hosts 112a-112d are aware of the identifiers of the cluster store communication endpoints so that any host can route requests to the cluster store leader and return results to the caller. Additionally, a low-level cluster identifier may be stored at all hosts 112a-112d in the same cluster to identify which cluster a host belongs to even if the complete membership (e.g., which hosts are included in a cluster) is not known.

The CMM circuitry 106 initiates the example cluster 102 by transmitting instructions to the example hosts 112a-112d to cause the hosts 112a-112d to operate as a cluster by sharing resources to perform operations. In the example of FIG. 1, the cluster 102 includes three hosts 112a-112c that include replicate datastores 120 and DKVS management circuitry 118 to implement the example DKVS 101. However, there may be any number of hosts that implement the DKVS 101. To establish quorum more than half of the hosts in the cluster 102 are implemented in the example DKVS 101. For example, if a cluster has five hosts, at least three of the five hosts may implement the example DKVS 101 to have quorum. The example hosts 112a-112d may communicate with each other (e.g., using the example hostd circuitry 114) to verify that the data stored in the datastore 120 are consistent, verify that there is quorum in the cluster 102, verify that the hosts 112a-112d are operational, etc. Additionally, the example hosts 112a-112d may communicate with each other to elect a leader host of the DKVS 101. An identification of the leader may be transmitted to the example CMM circuitry 106 so that the CMM circuitry 106 can communicate with the leader and the leader can communicate with the other follower hosts, if needed. If the leader goes down/offline and/or if the structure of the cluster 102 changes (e.g., hosts are removed and/or added), the remaining hosts that implement the DKVS 101 can readjust (e.g., by adding additional hosts to implement a replica database, if needed, to have quorum and/or to elect a new leader).

The example hostd circuitry 114 of the example hosts 112a-112d in FIG. 1 exports an ESX Admin API that manages the creation and deletion of the cluster 102, adding and removing hosts from a cluster 102, and deploying DKVS management circuitry 118 on specific ones of the hosts 112a-112d. The example hostd circuitry 114 acts as a communication channel and/or interface between hosts 112a-112 and/or to the example server manager circuitry 103.

The example cluster agent 116 of FIG. 1 exports an abstraction of the cluster 102. In this manner, the cluster agent 116 can swap in a new key-value store without affecting the interface that the cluster agent provides to upper layers of the host. The example cluster agent 116 provides administrative and client APIs that can be accessed on all hosts 112a-112d of the cluster 102. Additionally or alternatively, the example cluster agent 116 proxies requests from local clients on each host to cluster store nodes (e.g., the example hosts 112a-112c) without requiring clients to know about where the members are located. Additionally or alternatively, the example cluster agent 116 provides read/write operations to clients. The read/write operations can be used from one of the hosts 112a-112d from outside the host. Additionally or alternatively, the example cluster agent 116 provides administrative requests from the hostd circuitry 114 to the cluster store nodes (e.g., the hosts 112a-112c). The administrative requests may include “join,” “leave,” and/or any other requests that relate to reconfiguring the example cluster 102. The example cluster agent 116 is further described below in conjunction with FIG. 2B.

The example DKVS management circuitry 118 of FIG. 1 manages, reads, and/or writes of data in the example datastores 120 of the example DKVS 101. In some examples, the DKVS management circuitry 118 is implemented by Etcd from Kubernetes. Etcd is an open source distributed key-value store used to hold and manage information that distributed systems use to run. The example DKVS management circuitry 118 presents a key-value interface and guarantees strong mutual consistency of data stored in the example datastores 120. The example DKVS management circuitry 118 further provides atomic consistency of individual operations. To ensure correctness and/or consistency, the example DKVS management circuitry 118 operates based on reaching a majority consensus for each operations (e.g., which is why quorum may be needed). In some examples, the DKVS management circuitry 118 implementing the DKVS 101 may be referred to as a RootNamespace or DKVS management nodes (e.g., Etcd nodes). The set of hosts 112a-112c in the RootNamespace provide the high-availability/fault-tolerance of the DKVS 101 and the odd-numbered size of the set of hosts 112a-112c can be configured by the server manager circuitry 103 to achieve a desired fault-tolerance. The example cluster agents 116 can communicate with local or remote DKVS management circuitry 118. In some examples, the example DKVS management circuitry 118 may control a corresponding host 112a-112c to operate as a leader or a follower (e.g., the DKVS 101 may include one leader and multiple followers). As a leader, the DKVS management circuitry 118 may handle the reads and updates. As a follower, the DKVS management circuitry 118 can execute instructions from the leader. In this manner, the CMM circuitry 106 can choose to communicate with only one host in the cluster 102.

The example datastore 120 of FIG. 1 corresponds to the storage for the DKVS 101. The example datastore 120 stores key value tuples that relate to the structure of the cluster (e.g., cluster membership data and/or identifiers, host identifiers, leader information, the number of hosts, and/or any other information relate to the structure of the cluster). In some examples, the datastores 120 are referred to as replica datastores because the datastores 120 store the same information to provide high availability and fault tolerance (e.g., if one datastore is unavailable another can be used). To ensure consistency across the datastores 120, the DKVS management circuitry 118 stores data persistently to survive failures and reliability to reduce the likelihood of corruption. The DKVS management circuitry 118 values consistency over availability to ensure strong mutual consistency of the replica datastores 120.

FIG. 2A is a block diagram of the example CMM circuitry 106 of FIG. 1.

The example CMM circuitry 106 of FIG. 2A includes an example interface 200 (also referred to as interface circuitry), example cluster control circuitry 202, and example backup control circuitry 204.

The example interface 200 of FIG. 2A interfaces with other components of the example server manager circuitry 103 (FIG. 1). For example, the interface 200 may obtain instructions to set up one or more cluster using one or more hosts from a user interface or other device of the server management circuitry 103. Additionally, the example interface 200 may interface with the example VPXD circuitry 104 (FIG. 1) and/or other components to use a VMODL stub for making RPC calls to one or more of cluster agents 116 included in the hosts 112a-112d (FIG. 1). Additionally, the example interface 200 may obtain data (e.g., directly or via another component of the server management circuitry 103) from one or more of the hosts 112a-112d via the network 110. Additionally, the example interface 200 may transmit operations, commands, and/or instructions to the example DKVS management circuitry 118 to control and/or monitor the example DKVS 101.

The example cluster control circuitry 202 of FIG. 2A initializes clusters (e.g., the example cluster 102) and a distributed cluster store (e.g., the example DKVS 101) by generating and transmitting (e.g., via the example interface 200) operations, commands, and/or instructions to the example hosts 112a-112d of the cluster 102. For example, after receiving instructions to combine the example hosts 112a-112d into a cluster, the example cluster control circuitry 202 determines how many hosts will be part of the cluster in order to determine how many replica datastores are needed to have quorum. In the example of FIG. 1, there are four hosts 112a-112d in the cluster 102. Accordingly, the example cluster control circuitry 202 determines that at least three of the hosts will implement replica datastores to generate the DKVS 101 (e.g., because three is greater than half the hosts in the cluster, which corresponds to a quorum). The cluster control circuitry 202 may select particular hosts 112a-112d to implement the DKVS 101 and/or instruct the hosts 112a-112d to select which of the hosts will implement the DKVS 101. In some examples, the cluster control circuitry 202 and/or the hosts 112a-112d determine which of the hosts to implement the DKVS 101 based on capacity and/or capability of the hosts 112a-112d (e.g., by considering processing resource capacity and/or capability, memory resource capacity and/or capability, latency, throughput, etc. of the hosts 112a-112d). During the initiation process, the example cluster control circuitry 202 transmits cluster information (e.g., the leader of the DKVS 101, the configuration of the cluster, the number of hosts, etc.) to one or more of the example hosts 112a-112d to store in the example datastore 120. For example, if one of the hosts 112a-112c acts as a leader of the DKVS 101, the cluster control circuitry 202 may transmit the cluster information to the leader and the leader communications with the other hosts of the DKVS 101 so that the same data is stored in all the datastores 120 of the DKVS 101. In some examples, the cluster control circuitry 202 may transmit the cluster information to each of the hosts 112a-112c of the DKVS 101.

To initialize the DKVS 101, the example control circuitry 202 of FIG. 2A may transmit a bootstrap operation to the example cluster agents 116 (FIG. 1) one or more of the hosts 112a-112d. If the example hosts 112a-112d determine the hosts that will implement the DKVS 101, the hosts may forward the operation to one or more of the hosts that will implement the DKVS 101. The bootstrap operation is used to create a first replica host (e.g., by initializing the example cluster agent 116 and/or the example DKVS management circuitry 118 and reserving memory resources to implement the example datastore 120). The operation may be executed on hosts which are initially standalone hosts. The bootstrap instruction further brings the hosts 112a-112c of the DKVS 101 to a state where the respective hosts 112a-112c can begin taking key-value operations to store in the respective datastores 120.

After the bootstrap operation, the example control circuitry 202 may transmit a run replica operation. The example control circuitry 202 uses the run replica operation to add a host to an existing host as a replica member (e.g., to add another replica DKVS management circuitry 118 and the datastore 120 to another host in the cluster 102). For example, the control circuitry 202 may transmit the boot strap operation to initialize the first host 112a to implement the DKVS 101 and then use a run replica operation(s) to add the hosts 112b and 112c to the DKVS 101. The run replica operation may be executed on hosts which are initially standalone. The run replica operation initializes the example cluster agent 116 and/or the example DKVS management circuitry 118 and reserving memory resources to implement the example datastore 120. The run replica operation also configures the example cluster agent 116 and/or the example DKVS management circuitry 118 with the endpoint information and credential to allow the hosts to communicate with other hosts in the cluster 102. After a host implements a replica to join the DKVS 101, the host may still need to synchronize with other hosts in the background. Thus, after the run replica operation, the status of the newly added hosts are marked as “learner nodes” because they may not be ready to take key-value operations.

After the run replica operation, the example control circuitry 202 of FIG. 2A may transmit a promote replica operation. The example control circuitry 202 uses the promote replica operation to promote a learner node into a replica member of the DKVS 101 (e.g., a fully operational replica cluster store that can take key-value operations to distributed storage). The promote replica operation may be executed on learner nodes. The example control circuitry 202 may periodically transmit the promote replica operation after transmitting the run replica operation. If the host is synchronized and ready for promotion, the operation will succeed. If the host is not ready, the operation will fail. Upon success, the host will be in a state where it can take key-value operations to implement the DKVS 101.

In some examples, the control circuitry 202 of FIG. 2A may receive instructions to remove the implementation of DKVS 101 from one of the hosts and/or remove one or more hosts from the cluster 102. In such examples, the control circuitry 202 may transmit a force standalone operation to the host. The force standalone operation causes the host to clear its cluster membership and/or DKVS membership. If the force standalone operation corresponds to clearing DKVS membership, the operation instructs the host to remove the key-value data (e.g., corresponding to the cluster state information) stored in the datastore 120. In some examples, the control circuitry 202 uses a force standalone operation to remove the last member of a cluster when eliminating the cluster. In some examples, the control circuitry 202 uses a force standalone operation to clear and/or remove a broken, faulty, offline, and/or failed host from the DKVS 101.

In some examples, the control circuitry 202 of FIG. 2A may transmit a create user operation to prepare a new set of credentials based on a given username. In some examples, the control circuitry 202 uses the create user operation on a host operating as a replica prior to joining a new host using run replica operation to give the host a set of credentials the host can use to securely join he cluster 102 and/or DKVS 101. In some examples, the control circuitry 202 may transmit a delete user operation to remove an existing set of credentials based on a given username. The control circuitry 202 uses the delete user operation after the remove replica operation to clean up the ex-member's credentials, because the credentials are no longer needed. In some examples, the control circuitry 202 transmits a health operation to one or more of the hosts 112a-112d. The health operation is a read-only operation that can be used to cause the one or more hosts 112a-112d to return an overview of the health of the corresponding host. The control circuitry 202 may use the health operation for periodic monitoring of certain aspects (e.g., to determine if a host is at or below a fault tolerance level) of the hosts.

The example backup control circuitry 204 of FIG. 2A obtains cluster information from one or more of the hosts 112a-112d to determine the cluster state of all the connected hosts for the purposes of restarting operation in the current cluster state during a reboot, backup, etc. The example backup control circuitry 204 transmits cluster information requests to one or more of the hosts 112a-112d. For example, during a backup, the CMM circuitry 106 will not be aware of which connected hosts are included in a cluster. Accordingly, the example backup control circuitry 204 transmits an information request to the connected hosts. If the host is part of a DKVS (e.g., the DKVS 101) of a cluster (e.g., the cluster 102) and there is quorum, then the host will return the cluster information (e.g., which hosts are part of the cluster, the leader of the DKVS, the number of hosts, the number of hosts in the DKVS 101, etc.) to the backup control circuitry 204 (e.g., via the interface 200). If the host is not part of a DKVS (e.g., the DKVS 101) and/or there is not quorum, then the host will return a message that the cluster information is unknown or possibly inaccurate. The example backup control circuitry 204 continues to transmit requests to subsequent hosts that have not been previously linked to a cluster until all the connected nodes have been determined to be standalone or connected to a cluster (e.g., a host and/or cluster mapping). The backup control circuitry 204 can transmit (e.g., via the interface 200) the cluster information to another component of the example server manager circuitry 103 to operate according to the host and/or cluster mapping. To facilitate the development of the host and/or cluster mapping based on information requests to the one or more hosts 112a-112d, the backup control circuit 204 may transmit a status operation. The status operation is a read-only operation that the backup control circuitry 204 can use to ping a host operating in any state (e.g., as a standalone host, as a host implementing the DKVS 101, as a leader node, as a replica node, etc.).

FIG. 2B is a block diagram of the example cluster agent 116 of FIG. 1.

The example cluster agent 116 of FIG. 2B includes an example interface 206 (also referred to as interface circuitry), example health checking circuitry 208, and example cluster information control circuitry 210. The example cluster agent 116 is described in conjunction with the first host 112a. However, the cluster agent 116 could be implemented in any host.

The example interface 206 of FIG. 2B obtains commands, operations, instructions, etc. (e.g., directly or via one or more other components of the example host 112a) from the example CMM circuitry 106 of FIGS. 1 and/or 2A. Additionally, the example interface 206 transmits responses to requests for information. For example, if the interface 206 obtains instructions to transmit stored state data in the datastore 120 (FIG. 1), the interface 206 can transmit the stored state data in the datastore 120. If the host 112a is not implementing a replica datastore as part of the DKVS 101, then the example interface 206 may transmit a response indicative of no cluster or that the host is not part of the DKVS 101. In some examples, if the interface 206 receives a request for a health status of the host 112a, the example interface 206 may transmit a response indicative of the health.

The example health checking circuitry 208 of FIG. 2B checks the health of the host 112a in response to a health information request. The health checking circuitry 208 can check if there are any anomalies or performance below a threshold with respect to processor resources, memory, temperature, voltage, power, battery, storage, network issue, connectivity, throughput, latency, etc. If there are no issues (e.g., all monitored performance is within an acceptable range), the health checking circuitry 208 may generate a response to a health check that identifies that the host is healthy. If there is an issue, the health checking circuitry 208 may generate a response that identifies the one or more issues. The health information may further include host capability and/or capacity information.

The example cluster information control circuitry 210 of FIG. 2B facilitates operation of the host 112a as a member of the cluster 102 and/or a member of the DKVS 101. For example, when the interface 206 obtains instructions to configure the host to be part of the DKVS 101, the cluster information control circuitry 210 can initiate the DKVS management circuitry 118 and/or reserve a portion of memory to execute as the distributed datastore 120. Additionally, the example cluster information control circuitry 210 can synchronize the host 112a with other hosts that implement the example DKVS 101 in the background to be ready to take key-value operations to store cluster information in the datastore 120. In some examples, the CMM circuitry 106 can be able to call key-value or membership operations on any of the hosts 112a-112c. In some examples, the cluster information control circuitry 210 operates as a leader-agnostic interface to allow any host that is a member of the DKVS 101 to serve as a communication endpoint to the example server manager circuitry 103. Additionally, the example cluster information control circuitry 210 stores and/or accesses the key, value tuple(s) corresponding to the cluster state to/from the datastore 120. If the cluster is updated (e.g., based on instructions or a failure of one or more of the hosts 112a-112d), the cluster information control circuitry 210 updates the key, value tuple(s) in the datastore 120. Additionally, the example cluster information control circuitry 210 may perform one or more tasks to restructure the DKVS 101 in response to a change in the cluster structure. For example, if a host is added to the cluster, the cluster information control circuitry 210 updates the cluster state information in the datastore 120 and determines if additional hosts in the cluster need to implement a replica datastore to achieve quorum.

While example manners of implementing the CMM circuitry 106 and the cluster agent circuitry 116 of FIG. 1 are illustrated in FIGS. 2A and 2B, one or more of the elements, processes, and/or devices illustrated in FIGS. 2A and 2B may be combined, divided, re-arranged, omitted, eliminated, and/or implemented in any other way. Further, the example VPXD 104, the example hostd circuitry 114, the example DKVS management circuitry 118, the example interface 200, the example cluster control circuitry 202, the example backup control circuitry 204, the example interface 206, the example health checking circuitry 208, the example cluster information control circuitry 210, and/or, more generally, the CMM circuitry 106 and/or the cluster agent 116 of FIGS. 2A and 2B, may be implemented by hardware, software, firmware, and/or any combination of hardware, software, and/or firmware. Thus, for example, any of the example VPXD 104, the example hostd circuitry 114, the example DKVS management circuitry 118, the example interface 200, the example cluster control circuitry 202, the example backup control circuitry 204, the example interface 206, the example health checking circuitry 208, the example cluster information control circuitry 210, and/or, more generally, the CMM circuitry 106 and/or the cluster agent 116 of FIGS. 2A and 2B, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the CMM circuitry 106 and/or the cluster agent 116 of FIGS. 1, 2A, and/or 2B is/are hereby expressly defined to include a non-transitory computer readable storage device or storage disk such as a memory, a digital versatile disk (DVD), a compact disk (CD), a Blu-ray disk, etc., including the software and/or firmware. Further still, the CMM circuitry 106 and/or the cluster agent 116 of FIGS. 2A and 2B may include one or more elements, processes, and/or devices in addition to, or instead of, those illustrated in FIGS. 2A and 2B, and/or may include more than one of any or all of the illustrated elements, processes, and devices.

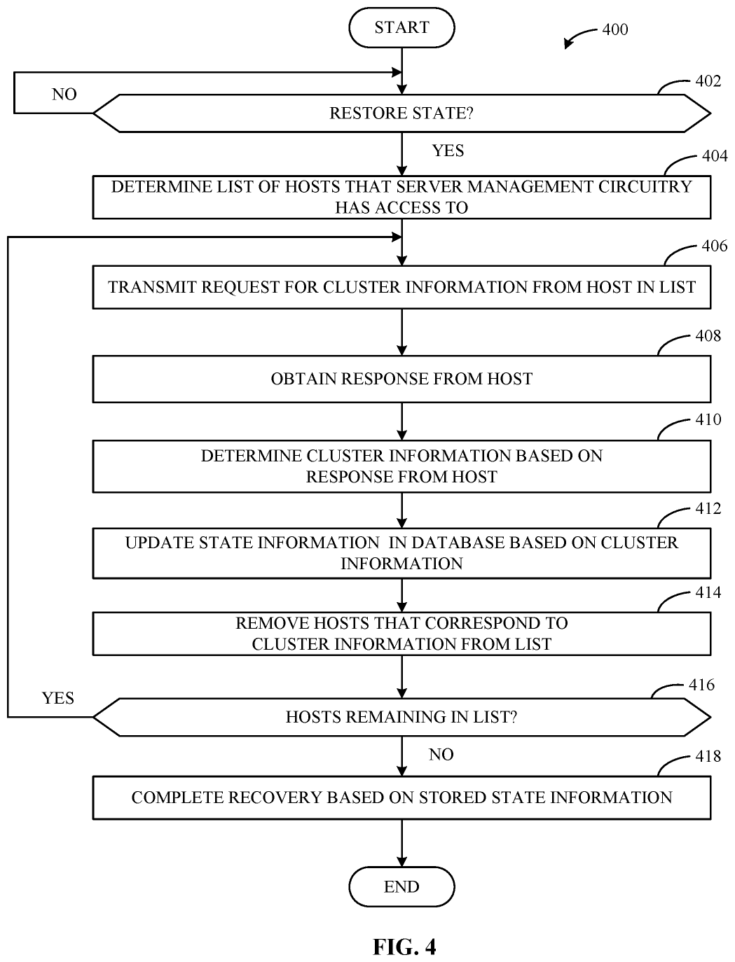

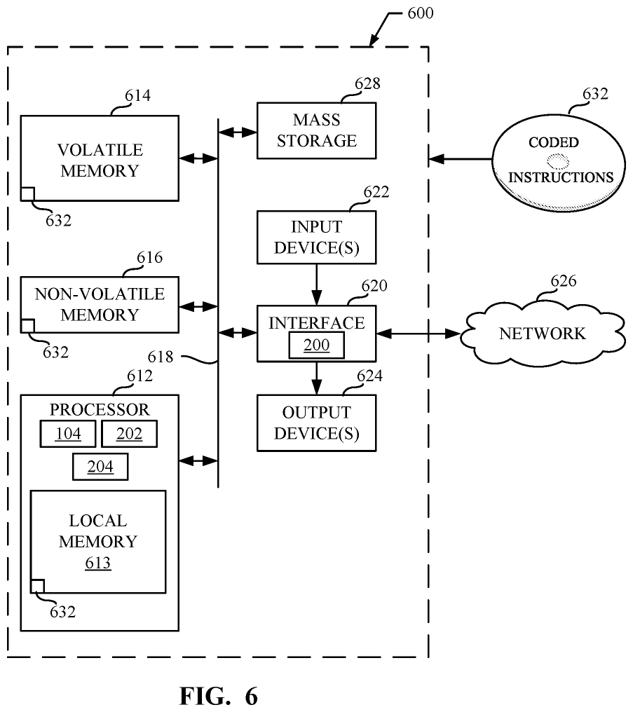

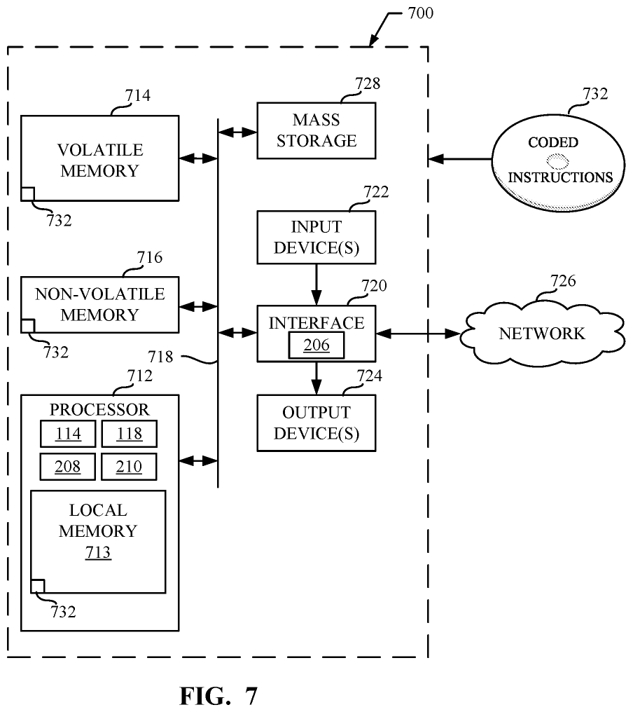

Flowcharts representative of example hardware logic circuitry, machine-readable instructions, hardware implemented state machines, and/or any combination thereof for implementing the CMM circuitry 106 and/or the cluster agent 116 are shown in FIGS. 3-5. The machine-readable instructions may be one or more executable programs or portion(s) of an executable program for execution by processor circuitry, such as the processor circuitry 612, 712 shown in the example processor platform 600, 700 discussed below in connection with FIGS. 6 and 7 and/or the example processor circuitry discussed below in connection with FIGS. 6 and 7. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 3-5, many other methods of implementing the CMM circuitry 106 and/or the cluster agent 116 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage devices and/or compute devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a compute device and/or other machine. For example, the machine-readable instructions may be stored in multiple parts, which are individually compressed, encrypted, and/or stored on separate compute devices, wherein the parts when decrypted, decompressed, and/or combined form a set of machine-executable instructions that implement one or more operations that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular compute device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3-5 may be implemented using executable instructions (e.g., computer and/or machine-readable instructions) stored on one or more non-transitory computer and/or machine-readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine-readable instructions and/or example operations 300 that may be executed and/or instantiated by processor circuitry (e.g., the example CMM circuitry 106 of FIGS. 1 and/or 2A) to set up the cluster 102 and/or a DKVS 101 of FIG. 1. The instructions begin at block 402 when the example interface 200 (FIG. 2A) determines if instructions to adjust and/or create a cluster of hosts have been received. As described above, a user and/or administrator may desire to combine two or more hosts into a cluster to share the resources of the hosts. In some examples, the interface 200 may obtain the instructions from one or more hosts 112a-112d of the cluster 102 (FIG. 1) itself. For example, if one or more hosts fail, one or more of the remaining hosts may transmit an alert to the example CMM circuitry 106 to determine if an adjustment is needed (e.g., to satisfy quorum). In some examples, a user and/or the cluster control circuitry 202 (FIG. 2A) itself may determine that the structure of the cluster 102 and/or the DKVS 101 (FIG. 1) should be adjusted based on health information of the hosts in the cluster. For example, the cluster control circuitry 202 may transmit a health operation to one or more of the hosts to obtain capability, capacity, and/or functionality information of the hosts 112a-112d in the cluster 102 and determine whether to adjust the structure of the cluster 102 and/or the DKVS 101 based on the health information (e.g., to increase efficiency of the cluster and/or load balance the cluster).

If the example interface 200 determines that instructions to adjust and/or create a cluster of hosts have not been received (block 302: NO), control returns to block 302 until instructions have been received or until a control-ending event (e.g., a program-end event, a power-down event, etc.). If the example interface 200 determines that instructions to adjust and/or create a cluster of hosts have been received (block 302: YES), the example cluster control circuitry 202 determines the number of hosts that will be included in the new and/or adjusted cluster based on the instructions (block 304). For example, the cluster control circuitry 202 may determine that the instructions correspond to the cluster 102 having four hosts 112a-112d. At block 306, the example cluster control circuitry 202 determines the number of replica datastores 120 (FIG. 1) needed to achieve quorum. As described above, quorum is reached by having more than half of the hosts implementing replica datastores 120 as part of the example DKVS 101. In the example of FIG. 1, the cluster control circuitry 202 determines that at least three hosts need to implement replica datastores to achieve quorum.

At block 308, the example cluster control circuitry 202 transmits instructions (e.g., via the network 110 using the example interface 200 and the example VPXD circuitry 104) to one or more of the hosts 112a-112d to set up and/or adjust the cluster 102 and/or the DKVS 101 based on the determined number of hosts and replica datastores. As described further above in conjunction with FIG. 2A, the example cluster control circuitry 202 may transmit one or more operations to one or more of the example hosts 112a-112d to set up and/or adjust the cluster 102 and/or the DKVS 101. For example, to set up the cluster 102 and/or the DKVS 101, the cluster control circuitry 202 may transmit a bootstrap operation, a run replica operation, a promote replica operation, and/or a create user operation to one or more of the hosts 112a-112d. To adjust a cluster 102 and/or DKVS 101, the example cluster control circuitry 202 may transmit a run replica operation, a promote replica operation, a remove replica operation, a force stand alone operation, a create user operation, and/or a delete user operation to one or more of the hosts 112a-112d. The example instructions of FIG. 3 end.

FIG. 4 is a flowchart representative of example machine-readable instructions and/or example operations 400 that may be executed and/or instantiated by processor circuitry (e.g., the example CMM circuitry 106 of FIGS. 1 and/or 2A) to perform a restore, reboot, recovery, etc. in response to an update, failure, backup, etc. of the server management circuitry 103 (FIG. 1). The instructions begin at block 302 when the example interface 200 (FIG. 2A) determines if instructions to restore the system state (e.g., redetermine which hosts belong to clusters) have been received. For example, in response to a restore, reboot, recovery, etc., the server management circuitry 103 (FIG. 1) will not know the system state because the system state is stored in the datastores 120 (FIG. 1) of the example DKVS 101 (FIG. 1). Accordingly, when a restore occurs, the server management circuitry 103 will transmit an instruction to the CMM circuitry 106 to determine the system state by communicating with the hosts 112a-112d (FIG. 1) to access cluster state information used to determine the system state.

At block 404, the example backup control circuitry 204 (FIG. 2A) determines and/or generates a list of hosts that the server management circuitry 103 has access to. For example, the backup control circuitry 204 may access identifiers (e.g., IP addresses) of hosts that the server management circuitry 103 stored in the example database 108 (FIG. 1) and that correspond to connected hosts. In some examples, the backup control circuitry 204 may determine the list based on any host that that server manager circuitry 103 has a connection with and/or can communicate with. At block 406, the example backup control circuitry 204 causes the example VPXD circuitry 104 (FIG. 1) to transmit a request for cluster information from a host in the list. For example, the backup control circuitry 204 may transmit (e.g., via the interface 200) a status operation to the VPXD circuitry 104 for a particular host and the VPXD circuitry 104 transmits (e.g., via the network 110) the status operation to the particular host.

At block 408, the example backup control circuitry 204 obtains a response from the host (e.g., via the network 110, the VPXD circuitry 104, and the interface 200). If the particular host implemented the DKVS 101 and there is a quorum, the host will return a response that identifies the cluster state of the cluster that the host is included in. For example, the status request was sent to the example host 112A of FIG. 1, the host 112A will transmit a response that identifies that the four hosts 112a-112d are included in the cluster 102, the three hosts 112a-112c are included in the DKVS 101, an identification of the leader of the DKVS 101, and/or any other information related to the DKVS 101 and/or the cluster 102. If the status request was sent to the example hosts 112d, the host 112d may return a response corresponding to the cluster information being unknown (e.g., because the host 112d is not included in the DKVS 101 and does not include the cluster information stored locally). If the status request was sent to a host of the DKVS 101 but there is not quorum, the host may respond with an error response and/or an identification that there is not quorum.

At block 410, example backup control circuitry 204 determines cluster information based on the response from the host. For example, if the response identifies hosts in a cluster, the backup control circuitry 204 determines that the hosts are part of the cluster. If the response corresponds to no cluster or no quorum, the backup control circuitry 204 determines that the host is a standalone host. In such examples, the host may or may not be a standalone host. However, as the backup control circuitry 204 continues to send responses to the rest of the connected hosts in the list, the backup control circuitry 204 can later identify that the host is not a standalone host as part of a response from another host. In some examples, if the backup control circuitry 204 determines, based on the response, that the host is part of a cluster that does not have a quorum, the backup control circuitry 204 may store a log of the request in the example database 108. As described above, the CMM circuitry 106 can maintain the log to reattempt to send the request at a later point in time (e.g., to give the cluster time to readjust to develop a quorum).

At block 412, the example backup control circuitry 204 updates the system state information (e.g., stored in the example database 108) based on the determined cluster information. For example, if the response identifies that the example hosts 112a-112d correspond to the cluster 102, the example hosts 112a-112c correspond to the DKVS 101 of the cluster 102, etc., the backup control circuitry 204 updates the system state information to identify the cluster 102 of the hosts 112a-112d, the DKVS 101, and/or any other information related to the cluster 102 and/or the DKVS 101. At block 414, the example backup control circuitry 204 removes the hosts (e.g., hosts 112a-112d) corresponding to the cluster (e.g., the cluster 102), if determined, from the list. For example, if the response identified the hosts 112a-112d in the cluster 102, the backup control circuitry 204 no longer needs to request information from any of the other hosts 112a-112d, because the cluster information is already known. Accordingly, the backup control circuitry 204 can remove the hosts 112a-112d from the list and continue to ping other hosts in the list to attempt to determine other clusters that may exist.

At block 416, the example backup control circuitry 204 determine if there are other connected hosts remaining in the list. If the example backup control circuitry 204 determines that there is at least one connected host still in the list (block 416: YES), control returns to block 406 so that the CMM circuitry 106 can continue to identify additional cluster information to update the system state information. If the example backup control circuitry 204 determines that there are no other connected hosts in the list (block 416: NO), the example server management circuitry completes recovery based on the stored system state information in the example database 108 (block 418). In this manner, cluster-based operation can continue as it left off before the server manager circuitry 103 was updated, restarted, failed, etc. In some examples, before moving forward to complete recovery, the CMM circuitry 106 may attempt to retransmit request(s) to hosts that have not been determined to be part of a cluster due to a quorum failure. In such examples, the CMM circuitry 106 accesses a log stored in the example database 108 to identify any previous request failures (e.g., due to lack of quorum) and retransmits the failed cluster information requests to one or more of the hosts 112a-112d.

The instructions of FIG. 4 end.

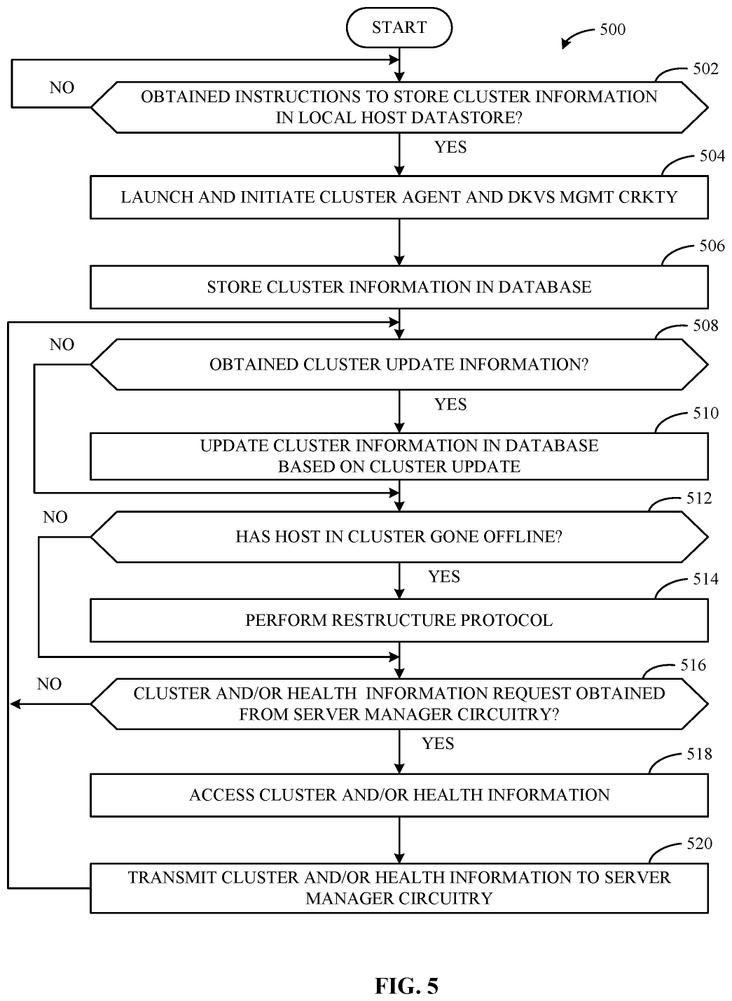

FIG. 5 is a flowchart representative of example machine-readable instructions and/or example operations 500 that may be executed and/or instantiated by processor circuitry (e.g., the example cluster agent 116 of FIGS. 1 and/or 2B) to initiate and/or operate as part of the cluster 102 and/or a DKVS 101 of FIG. 1. The instructions 500 of FIG. 5 are described in conjunction with obtaining instructions and/or operations directly from the server manager circuitry 103 (FIG. 1). However, in a leader-follower system, the instructions and/or operations may be obtained indirectly from the server manager circuitry 103 via a leader host.

The instructions begin at block 502 when the example hostd circuitry 114 (FIG. 1) determines if instructions (e.g., a bootstrap operation, a run replica operation, etc.) have been obtained (e.g., from the example server management circuitry 103 (FIG. 1) via the network 110 (FIG. 1)) to store cluster information in the local host datastore 120. If the example hostd circuitry 114 determines that the instructions have not been obtained (block 502: NO), control returns to block 502 until instructions have been obtained or until a control-ending event (e.g., a program-end event, a power-down event, etc.).

If the example hostd circuitry 114 determines that the instructions have been obtained (block 502: YES), the example hostd circuitry 114 launches and initiates the example cluster agent 116 (FIG. 1) and the example DKVS management circuitry 118 of FIG. 1 (block 504). As described above, the instructions from the server management circuitry 103 may include a bootstrap operation, a run replica operation and/or a promote replica operation. Accordingly, after the cluster agent 116 is launched based on the bootstrap operation, the cluster information control circuitry 210 (FIG. 2B) of the cluster agent 116 initializes using (a) the run replica to operate the host as a learner node and perform a synchronization protocol with other nodes and (b) the promote replica operation to promote the learner node to a full replica so that the host can begin taking key value operations corresponding to storing cluster information in the example datastore 120 (FIG. 1), as further described above. The synchronization between hosts 112a-112c (FIG. 1) implementing the DKVS 101 (FIG. 1) may include an election of a leader host directly responsible for communication with the server manager circuitry 103 (FIG. 1) via the network 110 (FIG. 1). In this manner, the server manager circuitry 103 can communicate with the leader and the leader can distribute the instructions from the server manager circuitry 103 to the other follower hosts of the DKVS 101. Additionally, any changes or alerts (e.g., updates in cluster configuration, errors of hosts in the cluster, etc.) from the hosts of the cluster can be communicated from the leader host to the server management circuitry 103.

At block 506, the example cluster information control circuitry 210 instructs the DKVS management circuitry 118 (FIG. 1) to store information related to the cluster 102 and/or DKVS 101 in the example datastore 120. Each of the hosts that implement the DKVS 101 store the same information in the respective datastores 120 to provide high availability, strong data consistency, persistence, and failure independence. At block 508, the example cluster information control circuitry 210 determines if cluster update information has been obtained via the interface 206. For example, a user may access the server management circuitry 103 to adjust the cluster by adding a new host to the cluster 102, removing a host from the cluster 102, replacing a cluster of the cluster 102, and/or adjusting the number of hosts acting as replicas in the DKVS 101. In such an example, the server management circuitry 103 may send over one or more instructions/operations to adjust the cluster 102 and/or the DKVS 101 based on the instructions of the user. In some examples, the server manager circuitry 103 may develop instructions (e.g., without the user) to adjust a cluster and/or DKVS 101 based on health information (e.g., information corresponding to the capability, availability, and/or functionality of the hosts 112a-112d in the cluster 102).

If the example cluster information control circuitry 210 determines that cluster information has not been obtained (block 508: NO), control continues to block 512. If the example cluster information control circuitry 210 determines that cluster information has been obtained (block 508: YES), the example cluster information control circuitry 210 instructs the DKVS management circuitry 118 to update the cluster information stored in the datastore 120 based on the update (block 510). For example, instructions relating to adding/removing a host to the cluster 102 and/or DKVS 101 will cause the cluster information control circuitry 210 to update the cluster state in the datastore 120 to add/remove the host. If the cluster update is a remove replace operation corresponding to removing the replica host node status from host, the cluster information control circuitry 210 may decommission and/or shut down the DKVS management circuitry 118 and/or remove the cluster state information from the datastore 120 (e.g., based on the remove replica operation and the delete user operation).

At block 512, the example cluster information control circuitry 210 determines if a host in the cluster 102 has gone offline and/or failed in some sort of way. For example, the cluster information control circuitry 210 may determine through communications with other hosts in the cluster 102 via the network 110, that one of the hosts has failed and/or gone offline. If the example cluster information control circuitry 210 determines a host in the cluster 102 has not gone offline or failed (block 512: NO), control continues to block 516. If the example cluster information control circuitry 210 determines that host of the cluster 102 has gone offline or failed (block 512: YES), the example cluster information control circuitry 210 performs a restructure protocol (block 514). The cluster restructure protocol restructures the cluster to ensure that the DKVS 101 still has a quorum and/or elects a new leader if the host that has gone offline is the leader. For example, the cluster information control circuitry 210 may determine that the cluster 102 still has a quorum (e.g., more than half of the hosts implement replicas of the DKVS 101) and the host that has gone offline was not a leader, the cluster information control circuitry 210 may determine that a restructure is not needed. If the cluster information control circuitry 210 determines that a quorum no longer exists when the host went offline and/or failed and/or the failed host was a leader, the cluster information control circuitry 210 determines how to restructure the cluster. For example, the cluster information control circuitry 210 may facilitate communications with other hosts in the cluster 102 to increase the number of replica hosts in the DKVS 101 by instructing a host to implement a replica datastore and/or elect a new leader. In some examples, when a host goes offline or fails, the example cluster information control circuitry 210 transmits an alert to the CMM circuitry 106 of the server manager circuitry 103 of FIG. 1. In such examples, the CMM circuitry 106 alerts a user and/or administrator of the offline host and/or failure and/or reconfigures the cluster 102 and/or DKVS 101 of the cluster 102. Additionally, the example cluster information control circuitry 210 can update the stored cluster information in the datastore 120 to indicate the restructure of the cluster 102, so that the cluster state data reflects the restructured cluster.

At block 516, the example cluster information control circuitry 210 determines if a cluster information request and/or a health information request was/were obtained from the server manager circuitry 103 via the example interface 206. As described above, the server manager circuitry 103 may transmit health information requests periodically, aperiodically, and/or based on a trigger. The health information request may request one or more hosts to provide health information such as status, capacity, capability, errors, etc. of the host. Additionally or alternatively, the server manager circuitry 103 may, during a reboot, recovery, restart, etc., a transmit cluster state information request from the one or more hosts 112a-112c of the DKVS 101 corresponding to cluster state information (e.g., the number and/or identifiers of hosts in a cluster, the number and/or identifier of hosts implementing the DKVS 101, the identifier of a leader, etc.).

If the example cluster information control circuitry 210 determines that cluster and/or health information requests have not been obtained from the example server manager circuitry 103 (block 516: NO), control returns to block 508. If the example cluster information control circuitry 210 determines that cluster and/or health information requests have been obtained from the example server manager circuitry 103 (block 516: YES), the health checking circuitry 208 and/or the cluster information control circuitry 210 accesses the cluster and/or health information (block 518). For example, for a health information request, the example health checking circuitry 208 determines the health of the host. For cluster state information, the example cluster information control circuitry 210 instructs the DKVS management circuitry 118 to access the cluster state information from the example datastore 120. In some examples, the health checking circuitry 208 instructs the DKVS management circuitry 118 to access the cluster state information when there is a quorum. If there is not a quorum, the cluster information control circuitry 210 may not access the cluster information and instead transmit a response indicative of no quorum. At block 520, the example interface 206 transmits the cluster and/or health information to the server manager circuitry 103 via the network 110 and control returns to block 508. The instructions of FIG. 5 end.

FIG. 6 is a block diagram of an example processor platform 600 structured to execute and/or instantiate the machine-readable instructions and/or operations of FIGS. 4 and 4 to implement the CMM circuitry 106 of FIG. 2A. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 600 of the illustrated example includes processor circuitry 612. The processor circuitry 612 of the illustrated example is hardware. For example, the processor circuitry 612 can be implemented by one or more integrated circuits, logic circuits, FPGAs microprocessors, CPUs, GPUs, DSPs, and/or microcontrollers from any desired family or manufacturer. The processor circuitry 612 may be implemented by one or more semiconductor based (e.g., silicon based) devices. In this example, the processor circuitry 612 implements the VPXD 104, the cluster control circuitry 202, and the backup control circuitry 204 of FIGS. 1 and/or 2A.

The processor circuitry 612 of the illustrated example includes a local memory 613 (e.g., a cache, registers, etc.). Access to the main memory 614, 616 of the illustrated example is controlled by a memory controller 617. The processor circuitry 612 of the illustrated example is in communication with a main memory including a volatile memory 614 and a non-volatile memory 616 by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. The example main memory 614, 616 and/or the local memory 613 may implement the example storage 108 of FIG. 1.

The processor platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. The example interface circuitry 620 may implement the example interface 200 of FIG. 2A.

In the illustrated example, one or more input devices 622 are connected to the interface circuitry 620. The input device(s) 622 permit(s) a user to enter data and/or commands into the processor circuitry 612. The input device(s) 622 can be implemented by, for example, an audio sensor, a microphone, a camera (still or video), a keyboard, a button, a mouse, a touchscreen, a track-pad, a trackball, an isopoint device, and/or a voice recognition system.

One or more output devices 624 are also connected to the interface circuitry 620 of the illustrated example. The output devices 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 600 of the illustrated example also includes one or more mass storage devices 628 to store software and/or data. Examples of such mass storage devices 628 include magnetic storage devices, optical storage devices, floppy disk drives, HDDs, CDs, Blu-ray disk drives, redundant array of independent disks (RAID) systems, solid state storage devices such as flash memory devices, and DVD drives. Any one of the memories 613, 614, 616, and/or the mass storage devices 628 may implement the example database 108 of FIG. 1.

The machine executable instructions 632, which may be implemented by the machine-readable instructions of FIGS. 3 and/or 5, may be stored in the mass storage device 628, in the volatile memory 614, in the non-volatile memory 616, and/or on a removable non-transitory computer readable storage medium such as a CD or DVD.

FIG. 7 is a block diagram of an example processor platform 700 structured to execute and/or instantiate the machine-readable instructions and/or operations of FIG. 5 to implement the cluster agent 116 of FIG. 2B. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example hosted 114, the example DKVS management circuitry 118, the example health checking circuitry 208, and the example cluster information control circuitry 210 of FIGS. 1 and/or 2B.

The processor circuitry 712 of the illustrated example includes a local memory 713 (e.g., a cache, registers, etc.). Access to the main memory 714, 716 of the illustrated example is controlled by a memory controller 717. The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. The example main memory 714, 716 and/or the local memory 713 may implement the example datastore 120 of FIG. 1.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. The example interface circuitry 720 may implement the example interface 206 of FIG. 2B.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices, and DVD drives. Any one of the example memories 713, 714, 716, and/or the example mass storage devices 728 may implement the example datastores 120.

The machine-executable instructions 732, which may be implemented by the machine-readable instructions of FIG. 5, may be stored in the mass storage device 728, in the volatile memory 714, in the non-volatile memory 716, and/or on a removable non-transitory computer readable storage medium such as a CD or DVD.

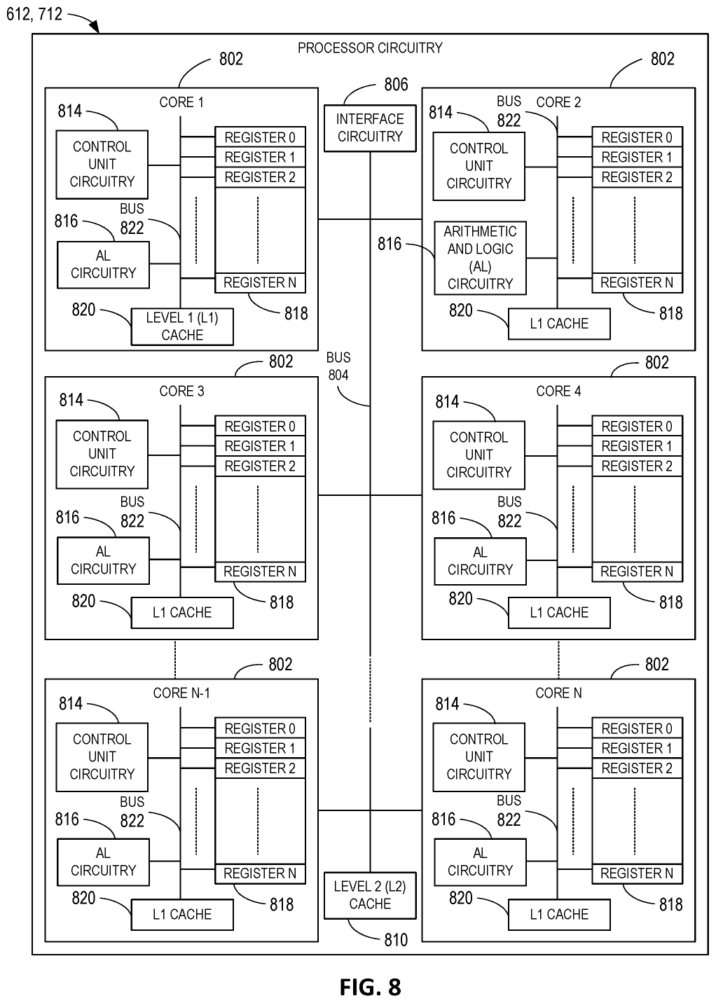

FIG. 8 is a block diagram of an example implementation of the processor circuitry 612, 712 of FIGS. 6 and/or 7. In this example, the processor circuitry 612, 712 of FIGS. 6 and/or 7 is implemented by a microprocessor 612, 712. For example, the microprocessor 800 may implement multi-core hardware circuitry such as a CPU, a DSP, a GPU, an XPU, etc. Although it may include any number of example cores 802 (e.g., 1 core), the microprocessor 612, 712 of this example is a multi-core semiconductor device including N cores. The cores 802 of the microprocessor 612, 712 may operate independently or may cooperate to execute machine-readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine-readable instructions and/or operations represented by the flowchart of FIG. 3-5.

The cores 802 may communicate by an example bus 804. In some examples, the bus 804 may implement a communication bus to effectuate communication associated with one(s) of the cores 802. For example, the bus 804 may implement at least one of an Inter-Integrated Circuit (I2C) bus, a Serial Peripheral Interface (SPI) bus, a PCI bus, or a PCIe bus. Additionally or alternatively, the bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 612, 712 also includes example shared memory 810 that may be shared by the cores (e.g., Level 2 (L2_cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 615, 716, 714, 716 of FIGS. 6 and/or 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814 (e.g., control circuitry), arithmetic, and logic (AL) circuitry (sometimes referred to as an ALU) 816, a plurality of registers 818, the L1 cache 820, and an example bus 822. Other structures may be present. For example, each core 802 may include vector unit circuitry, single instruction multiple data (SEVID) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The bus 822 may implement at least one of an I2C bus, a SPI bus, a PCI bus, or a PCIe bus

Each core 802 and/or, more generally, the microprocessor 612, 712 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 612, 712 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

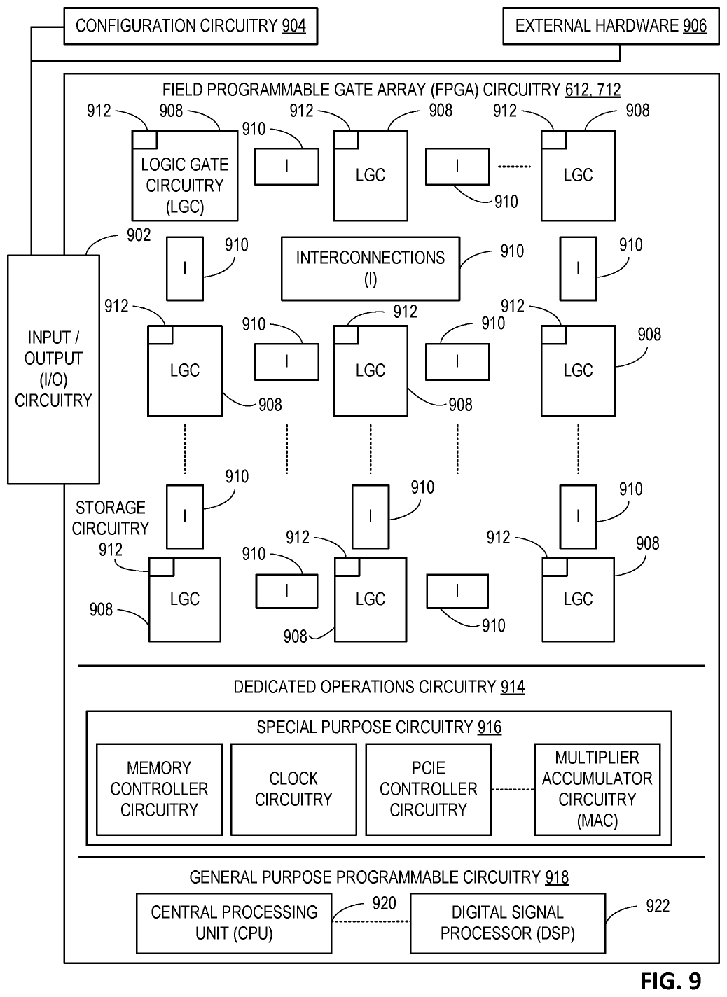

FIG. 9 is a block diagram of another example implementation of the processor circuitry 612, 712 of FIGS. 6 and/or 7. In this example, the processor circuitry 612, 712 is implemented by FPGA circuitry 612, 712. The FPGA circuitry 612, 712 can be used, for example, to perform operations that could otherwise be performed by the example microprocessor 612, 712 of FIG. 8 executing corresponding machine-readable instructions. However, once configured, the FPGA circuitry 612, 712 instantiates the machine-readable instructions in hardware and, thus, can often execute the operations faster than they could be performed by a general purpose microprocessor executing the corresponding software.

More specifically, in contrast to the microprocessor 612, 712 of FIG. 8 described above (which is a general purpose device that may be programmed to execute some or all of the machine-readable instructions represented by the flowchart of FIGS. 3-5 but whose interconnections and logic circuitry are fixed once fabricated), the FPGA circuitry 612, 712 of the example of FIG. 9 includes interconnections and logic circuitry that may be configured and/or interconnected in different ways after fabrication to instantiate, for example, some or all of the machine-readable instructions represented by the flowchart of FIGS. 3-5. In particular, the FPGA 712 may be thought of as an array of logic gates, interconnections, and switches. The switches can be programmed to change how the logic gates are interconnected by the interconnections, effectively forming one or more dedicated logic circuits (unless and until the FPGA circuitry 612, 712 is reprogrammed). The configured logic circuits enable the logic gates to cooperate in different ways to perform different operations on data received by input circuitry. Those operations may correspond to some or all of the software represented by the flowchart of FIGS. 3-5. As such, the FPGA circuitry 612, 712 may be structured to effectively instantiate some or all of the machine-readable instructions of the flowchart of FIGS. 3-5 as dedicated logic circuits to perform the operations corresponding to those software instructions in a dedicated manner analogous to an ASIC. Therefore, the FPGA circuitry 612, 712 may perform the operations corresponding to the some or all of the machine-readable instructions of FIG. 9 faster than the general purpose microprocessor can execute the same.

In the example of FIG. 9, the FPGA circuitry 612, 712 is structured to be programmed (and/or reprogrammed one or more times) by an end user by a hardware description language (HDL) such as Verilog. The FPGA circuitry 612, 712 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine-readable instructions to configure the FPGA circuitry 612, 712, or portion(s) thereof. In some such examples, the configuration circuitry 904 may obtain the machine-readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 906 may implement the microprocessor 612, 712 of FIG. 8. The FPGA circuitry 612, 712 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine-readable instructions of FIGS. 3-5 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 612, 712 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 612, 712 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 612, 712 of FIGS. 6 and/or 7, many other approaches are contemplated. For example, as mentioned above, modern FPGA circuitry may include an on-board CPU, such as one or more of the example CPU 920 of FIG. 9. Therefore, the processor circuitry 612, 712 of FIGS. 6 and/or 7 may additionally be implemented by combining the example microprocessor 612, 712 of FIG. 8 and the example FPGA circuitry 612, 712 of FIG. 9. In some such hybrid examples, a first portion of the machine-readable instructions represented by the flowchart of FIGS. 3-5 may be executed by one or more of the cores 802 of FIG. 8 and a second portion of the machine-readable instructions represented by the flowchart of FIGS. 3-5 may be executed by the FPGA circuitry 612, 712 of FIG. 9.

In some examples, the processor circuitry 612, 712 of FIGS. 6 and/or 7 may be in one or more packages. For example, the processor circuitry 712 of FIG. 8 and/or the FPGA circuitry 612, 712 of FIG. 9 may be in one or more packages. In some examples, an XPU may be implemented by the processor circuitry 612, 712 of FIGS. 6 and/or 7, which may be in one or more packages. For example, the XPU may include a CPU in one package, a DSP in another package, a GPU in yet another package, and an FPGA in still yet another package.

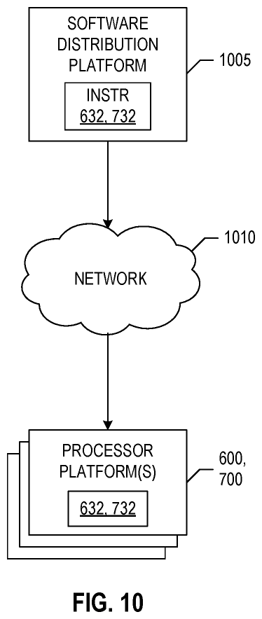

A block diagram illustrating an example software distribution platform 1005 to distribute software such as the example machine-readable instructions 632, 732 of FIGS. 6 and/or 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine-readable instructions 632, 732 of FIGS. 6 and/or 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine-readable instructions 632, 732, which may correspond to the example machine-readable instructions 300, 400, 500 of FIGS. 3-5, as described above. The one or more servers of the example software distribution platform 1005 are in communication with a network 1010, which may correspond to any one or more of the Internet and/or any example network. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 732 from the software distribution platform 1005. For example, the software, which may correspond to the example machine-readable instructions 300, 400, 500 of FIGS. 3-5, may be downloaded to the example processor platform 600, 700, which is to execute the machine-readable instructions 632, 732 to implement the CMM circuitry 106 and/or the cluster agent 116. In some example, one or more servers of the software distribution platform 1005 periodically offer, transmit, and/or force updates to the software (e.g., the example machine-readable instructions 632, 732 of FIGS. 6 and/or 7) to ensure improvements, patches, updates, etc., are distributed and applied to the software at the end user devices.

From the foregoing, it will be appreciated that example systems, methods, apparatus, and articles of manufacture have been disclosed that store cluster information in a distributed datastore. Conventional techniques store system state information directly on the server manager. However, such system state information is frequently out-of-date. Accordingly, performing a back-up to an out-of-date cluster configuration will result in additional errors and/or problems. Additionally, if the database of the conventional server manager is corrupted, the system state information is lost. Examples disclosed herein store system state information in a distributed datastore on the cluster itself. In this manner, when a cluster store experiences a hardware and/or software error, the server manager can ping the connected hosts to identify clusters. Accordingly, examples disclosed herein result in a highly available, strongly consistent, failure dependent and persistent distributed datastore that results in more effective backups and/or restores of the server manager so that the server manager can utilize the clusters using up-to-date system state information. Disclosed systems, methods, apparatus, and articles of manufacture are accordingly directed to one or more improvement(s) in the operation of a machine such as a computer or other electronic device.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. A system to perform an architecture search, the system comprising:
memory;
programmable circuitry; and
first instructions to cause the programmable circuitry to:
obtain second instructions to create a cluster of first hosts;
determine second hosts of the cluster of the first hosts to implement a distributed datastore in the cluster; and
cause transmission of third instructions to store cluster information corresponding to the cluster of the first hosts in datastores of the second hosts.

2. The system of claim 1, wherein the third instructions are to cause the second hosts to store the same cluster information.

3. The system of claim 1, wherein the third instructions are to cause the second hosts to initiate an agent and a manager of the datastores.

4. The system of claim 1, wherein the third instructions are to cause the second hosts to set up the cluster of the first hosts.

5. The system of claim 1, wherein the third instructions include at least one of (a) a bootstrap instruction to initiate a first host of the second hosts as a first replica host, (b) a run replica host instruction to convert a second host of the second hosts to a learner host, the second host to synchronize with the first replica host, or (c) a promote replica instruction to promote the second host from the learner host to a second replica host.

6. The system of claim 1, wherein the programmable circuitry is to, during a restore operation:
generate a list of connected hosts;
transmit a request to a connected host in the list, the request to obtain second cluster information from the connected host in the list; and
update system state information based on a cluster information response from the connected host.

7. The system of claim 6, wherein the request is a first request, the cluster is a first cluster, and the connected host is a first connected host, the programmable circuitry to:
remove third hosts from the list based on the third hosts corresponding to the second cluster information;
transmit a second request for third cluster information from a second connected host in the list; and
update the system state information based on a second cluster information response from the second host.

8. The system of claim 7, wherein the programmable circuitry is to resume operation based on the system state information.

9. The system of claim 1, wherein the programmable circuitry is to transmit a request for health information from at least one of the first hosts.

10. The system of claim 1, wherein the programmable circuitry is to, in response to an alert from at least one of the first hosts, reconfigure the cluster.

11. A non-transitory computer-readable storage medium comprising first instructions which, when executed, cause one or more processors to at least:
obtain second instructions to create a cluster of first hosts;
determine second hosts of the cluster of the first hosts to implement a distributed datastore in the cluster; and
cause transmission of third instructions to store information corresponding to the cluster of the first hosts in memory of the second hosts.

12. The computer-readable medium of claim 11, wherein the third instructions are to cause the second hosts to store the same cluster information.

13. The computer-readable medium of claim 11, wherein the third instructions are to cause the second hosts to initiate an agent and a manager of the datastore.

14. The computer-readable medium of claim 11, wherein the third instructions are to cause the second hosts to set up the cluster of the first hosts.

15. The computer-readable medium of claim 11, wherein the third instructions include at least one of (a) a bootstrap instruction to initiate a first host of the second hosts as a first replica host, (b) a run replica host instruction to convert a second host of the second hosts to a learner host, the second host to synchronize with the first replica host, or (c) a promote replica instruction to promote the second host from the learner host to a second replica host.

16. The computer-readable medium of claim 11, wherein the first instructions are to cause the one or more processors to, during a restore operation:
generate a list of connected hosts;
transmit a first request to a connected host in the list, the first request to obtain cluster information from the connected host in the list; and
update system state information based on a cluster information response from the connected host.

17. The computer-readable medium of claim 16, wherein the first instructions are to cause the one or more processors to:
remove third hosts corresponding to the cluster information from the list;
transmit a second request for second cluster information from a second connected host in the list; and
update the system state information based on a second cluster information response from the second host.

18. The computer-readable medium of claim 17, wherein the first instructions are to cause the one or more processors to resume operation based on the system state information.

19. The computer-readable medium of claim 11, wherein the first instructions are to cause the one or more processors to cause transmission of a request for health information from at least one of the first hosts.

20. A method comprising
receiving first instructions to create a cluster of first hosts;
determining, by executing a second instruction with one or more processors, second hosts of the cluster of the first hosts to implement a distributed key value datastore in the cluster; and
transmit operation identifiers to the second hosts to cause the second hosts to store cluster information corresponding to the cluster of the first hosts in datastores of the second hosts.

21-28. (canceled)
